(19) United States
(12) Patent Application Publication
(10) Pub. No.: US 2023/0100485 A1
(43) Pub. Date: Mar. 30, 2023

(54) NEURAL CONSENSUS-BASED BLOCKCHAIN NETWORK SYSTEM FOR PERFORMING RANDOM CONSENSUS PROOF USING NON-RANDOM CONSENSUS PROOF-BASED BLOCKCHAIN NETWORK

(71) Applicant: LEADPOINT SYSTEM INC., Jeonju-si (KR)

(72) Inventors: Eun Ju BAEK, Namyangju-si (KR); Do Hyoung KIM, Namyangju-si (KR)

(21) Appl. No.: 18/059,902

(22) Filed: Nov. 29, 2022

Related U.S. Application Data
(63) Continuation of application No. PCT/KR2021/011842, filed on Sep. 2, 2021.

(30) Foreign Application Priority Data
Apr. 29, 2021 (KR) 10-2021-0055357
Apr. 29, 2021 (KR) 10-2021-0055358

(51) Int. Cl. H04L 9/32; H04L 9/00

(52) U.S. Cl. CPC H04L 9/32; H04L 9/50

(57) ABSTRACT

A blockchain network platform system according to an embodiment of the present invention comprises: a non-random consensus proof-based blockchain network; and a neural consensus proof module cluster for generating a new block, combined with random-consensus proof-based neural consensus validity verification data, by using block data propagated from the non-random consensus proof-based blockchain network, wherein the new block is propagated through the non-random consensus proof-based blockchain network.

### CROSS-REFERENCE TO RELATED APPLICATIONS

This application is a continuation of pending PCT International Application No. PCT/KR2021/011842, filed on Sep. 2, 2021, which claims priority to Korean Patent Application No. 10-2021-0055357 filed on Apr. 29, 2021, and Korean Patent Application No. 10-2021-0055358 filed on Apr. 29, 2021, the entire contents of which are hereby incorporated by references in its entirety.

### TECHNICAL FIELD

The present invention relates to an apparatus for constructing a blockchain network and an operation method thereof. More specifically, the present invention relates to a neural consensus-based blockchain network system for performing random consensus proof using a non-random consensus proof-based blockchain network.

### BACKGROUND ART

Generally, a blockchain utilizes a peer-to-peer (P2P) network as one of distributed databases. A distributed database is a technique of distributing data physically so that a plurality of users may share a large-scale database. The blockchain is a list of structure that stores data, and node terminals participating in the network may store data and jointly record and manage ledger data that records transaction information through verification.

As an example of blockchain utilization, a blockchain may be constructed by node terminals of virtual currency users connected through the Internet to configure a P2P network. Through this, blocks containing transaction details of virtual currency may be managed in a user node terminal, and connected to new blocks and propagated. When a new block is generated, a block that is verified through a consensus algorithm of a plurality of participants (node terminals) may be connected to existing blocks, confirmed as a final ledger containing transaction details, and stored in a distributed manner. In addition, when a transaction occurs in a participating node terminal, transaction information verified through validity verification on the transaction is propagated to each node terminal. Through this, transaction details, i.e., verified transactions, are propagated and stored in a distributed manner, and when some nodes falsify the data, authenticity may be identified based on the transactions stored in a distributed manner. The security stability of the blockchain increases as more users share the data. The blockchain is utilized for various online services such as cloud computing service and the like, in addition to Bitcoin.

The blockchain technique may reduce transaction cost and prevent data forgery and falsification by changing the existing centralized data management structure to a decentralized or distributed data management structure. Such a blockchain technique may generate economic values in combination with industries such as finance, medical, contents, public, logistics, distribution, and energy sectors.

In the blockchain, a node participating in a network may generate a block and propagate information on the generated block to other nodes. In addition, nodes receiving new block information may determine and verify consistency of the new block information. At this point, transaction details that can be included in the newly generated block, i.e., validity verification on the transaction, may also be performed in the nodes participating in the blockchain network.

In addition, a consensus algorithm may be applied to the blockchain network to guarantee integrity and review legitimacy of the block information constituting the ledger managed by the participating nodes. As the consensus algorithm, generally, Proof-of-Work (PoW), Proof-of-Stake (PoS), Delegated Poof of Stake (DPoS), Practical Byzantine Fault Tolerance (PBFT), and the like are applied.

The Proof-of-Work (PoW) is a method of suppressing denial by proving that resources (e.g., computing power, etc.) are used for a work, and participating nodes should use resources to participate in the Proof-of-Work (PoW). Even a spam or DoS attack will succeed when 51% or more of resources are used.

The POW needs a unique hash value to generate a block. Here, since the unique hash value is a value that should be found by randomly substituting a nonce value, resources such as computing power or the like should be excessively spent in order to find such a unique hash value, and therefore, problems occur in the cost and environment due to power consumption, and chips with aggregated functions appear separately, and therefore, a centralization problem may occur due to unity of computing power.

Proof-of-Stake (PoS) has been proposed to solve this problem, and the PoS adopts a method that can make a proof in proportion to the stake possessed by a node. PoS makes it possible that the probability of generating a block is proportional to the stake of token that each node has. When PoS is regarded as a resource that spends the stake of token, PoW may be regarded as a specific type of the PoW. The algorithm formula of the PoS may be expressed as a ‘PoW using digest’. Compared to the PoW, the PoS almost does not consume energy and makes it difficult to aggregate resources.

However, since PoS is a method that becomes more advantageous with more stakes, a block generation centralization problem may occur due to the stake, and each node tends only to collect and not to use the tokens. Furthermore, since the stake reaches 100% at the Genesis block time point, which corresponds to the first block of the blockchain, a person who starts the system may recreate the entire block again without limitation. Since each node may start again from that time point only if it has a stake, PoS alone cannot prevent forgery and falsification.

To solve this problem, Korean Laid-Opened Patent No. 10-2019-0122149 discloses a method of selecting a consensus node using a nonce. Since this method uses a fair random consensus, it does not need to excessively use resources like PoW, and it has an advantage of minimizing consumption of resources as only some of nodes selected as a consensus according to a nonce chain participate in generation of a block, making it unable to predict nodes that will acquire the block generation authority through a nonce proof process, and selecting more than a predetermined number of consensus nodes that probabilistically represent all the nodes.

Nevertheless, blockchain networks that have already been constructed around the world, such as Bitcoin and Ethereum, still use the PoW and Pow methods, and as private blockchain networks operate networks, in which only small-scale nodes may participate, like PBFT in order to preserve efficiency in the communication amount, although a new network is constructed by proposing a new consensus method, it is very difficult to quickly overcome the waste of resources and social cost generated by the existing blockchain networks that have already been extensively constructed.

### DISCLOSURE OF INVENTION

### Technical Problem

Therefore, the present invention has been made in view of the above problems, and it is an object of the present invention to provide an apparatus and an operation method thereof, and a new blockchain network system based on the apparatus and method, which support a random consensus proof-based blockchain network to operate on a previously constructed blockchain network, while controlling a previously constructed blockchain network of an existing PoW or PoS method so as not to operate in the PoW or PoS method any longer, by constructing a neural consensus proof module cluster that uses an existing non-random consensus proof-based blockchain network as a random consensus proof-based blockchain network.

### Technical Solution

To accomplish the above object, according to one aspect of the present invention, there is provided an operation method of a node device connected to a non-random consensus proof-based blockchain network, the method comprising the steps of: acquiring new block data propagated through the blockchain network; and performing a neural consensus proof-based block generation process corresponding to the new block data according to a condition set in advance, wherein the neural consensus proof-based block generation process includes the steps of: extracting validity verification data from the new block data; acquiring neural consensus designation information of a next block generated based on a random consensus proof process according to a verification process on the validity verification data; and generating validity verification data of the next block by selectively operating a consensus node function unit on the basis of the neural consensus designation information of the next block.

According to another aspect of the present invention, there is provided a node device connected to a non-random consensus proof-based blockchain network to perform a neural consensus proof-based block generation process corresponding to new block data according to a condition set in advance when the node device acquires the new block data propagated through the blockchain network, the node device comprising: a validity verification processing unit acquiring the new block data propagated through the blockchain network, extracting validity verification data from the new block data, and acquiring neural consensus designation information of the next block generated based on the random consensus proof process according to the verification process on the validity verification data; and a consensus node function unit selectively operated based on the neural consensus designation information of the next block to generate validity verification data of the next block.

According to another aspect of the present invention, there is provided a blockchain network platform system comprising: a non-random consensus proof-based blockchain network; and a neural consensus proof module cluster for generating a new block combined with random consensus proof-based neural consensus validity verification data by using block data propagated from the non-random consensus proof-based blockchain network according to a condition set in advance, wherein the new block is propagated through the non-random consensus proof-based blockchain network.

### Advantageous Effects

According to an embodiment of the present invention, as a neural consensus proof module cluster, which uses an existing non-random consensus proof-based blockchain network as a random consensus proof-based blockchain network, is constructed, it is possible to provide a node terminal device that forms a network and an operation method thereof, which allow a random consensus proof-based blockchain network to operate on a previously constructed blockchain network, while controlling the previously constructed blockchain network of an existing PoW or PoS method not to operate in the PoW or PoS method any longer, or controlling to operate in a limited manner according to the minimum number of nodes of Byzantine Fault Tolerance Agreement consensus.

Accordingly, as a previously constructed non-random consensus proof-based blockchain network may be switched to be utilized as a random consensus proof-based blockchain network while maintaining the infrastructure and utility as much as possible, it is possible to provide an apparatus and an operation method thereof, which provide an efficient and fair neural consensus proof-based distributed consensus process while preventing waste of resources and social cost.

In addition, according to an embodiment of the present invention, it is possible to operate a continuity guarantee mode which can be configured to subsidiary process using a random consensus proof-based blockchain network only when a failure condition occurs so that service continuity can be maintained when a failure occurs in the current non-random consensus proof-based blockchain network, and accordingly, the present invention may also be used to guarantee service continuity of existing services.

### BRIEF DESCRIPTION OF THE DRAWINGS

FIG. 1 is a view schematically showing the entire system according to an embodiment of the present invention, and FIG. 2 is a view for explaining a blockchain network according to an embodiment of the present invention.

FIG. 3 is a block diagram showing a node device according to an embodiment of the present invention in more detail.

FIG. 4 is a conceptual view for explaining the configuration of a neural consensus proof module cluster and the overall process according to an embodiment of the present invention.

FIG. 5 is a flowchart illustrating an operation method of a node device according to an embodiment of the present invention.

FIGS. 6 to 9 are views showing step-by-step data processed by a consensus proof module node device according to an embodiment of the present invention.

FIG. 10 is a flowchart illustrating an operation method of a node device according to another embodiment of the present invention.

FIG. 11 is a flowchart illustrating an operation method of a node terminal device according to another embodiment of the present invention.

### BEST MODE FOR CARRYING OUT THE INVENTION

Hereinafter, only the principles of the present invention will be exemplified. Therefore, although not clearly described or shown in this specification, those skilled in the art will be able to implement the principles of the present invention and invent various devices included in the spirit and scope of the present invention. In addition, it should be understood that all conditional terms and embodiments listed in this specification are, in principle, clearly intended only for the purpose of understanding the concept of present invention, and not limited to the embodiments and states specially listed as such.

In addition, it should be understood that all detailed descriptions listing specific embodiments, as well as the principles, aspects, and embodiments of the present invention, are intended to include structural and functional equivalents of such matters. In addition, it should be understood that such equivalents include equivalents that will developed in the future, as well as currently known equivalents, i.e., all devices invented to perform the same function regardless of the structure.

Accordingly, for example, the block diagrams in the specification should be understood as expressing the conceptual viewpoints of illustrative circuits that embody the principles of the present invention. Similarly, all flowcharts, state transition diagrams, pseudo code, and the like may be practically embodied on computer-readable media, and it should be understood that regardless of whether or not a computer or processor is explicitly shown, they show various processes performed by the computer or processor.

In addition, explicit use of the terms presented as processors, controls, or concepts similar thereto should not be interpreted by exclusively quoting hardware having an ability of executing software, and should be understood to implicitly include, without limitation, digital signal processor (DSP) hardware, and ROM, RAM and non-volatile memory for storing software. Other known common hardware may also be included.

The above objects, features and advantages will become more apparent through the following detailed description related to the accompanying drawings, and accordingly, those skilled in the art may easily implement the technical spirit of the present invention. In addition, when it is determined in describing the present invention that the detailed description of a known technique related to the present invention may unnecessarily obscure the gist of the present invention, the detailed description thereof will be omitted.

Hereinafter, a preferred embodiment according to the present invention will be described in detail with reference to the accompanying drawings.

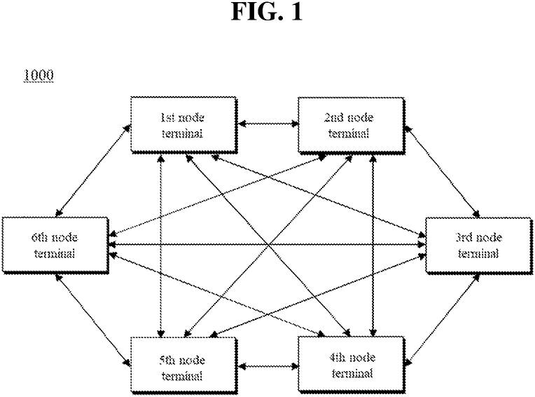

FIG. 1 is a view schematically showing the entire system according to an embodiment of the present invention, and FIG. 2 is a view for explaining a blockchain network according to an embodiment of the present invention.

First, referring to FIG. 1, a blockchain network system 1000 according to an embodiment of the present invention may configure a blockchain network of a mesh network topology by one or more node terminals connected through a wired or wireless network. The node terminals may be connected to the blockchain network through an input/output device and exchange data with each other. The blockchain network system 1000 may include various electronic systems, such as a mobile device including a mobile phone, a smart phone, a PDA, a tablet computer, a laptop computer or the like, a computing device including a personal computer, a tablet computer, a netbook computer or the like, a television, a smart television, a security device for gate control and the like, as the node terminal.

In addition, each node terminal 100 may be provided with a communication module for accessing a blockchain network. The blockchain network may be implemented as a wired network such as a local area network (LAN), a wide area network (WAN), or a value-added network (VAN). In addition, the blockchain network may be implemented as all kinds of wireless networks such as a mobile radio communication network, a satellite communication network, Bluetooth, Wireless Broadband Internet (WiBro), High Speed Downlink Packet Access (HSDPA), Wi-Fi, Long Term Evolution (LTE), and the like. If necessary, the blockchain network may be a network in which wired and wireless networks are mixed.

In addition, each node terminal may register account information according to its own node access into transaction ledger data shared in a cloud method through a network. In addition, when trade of encryption information for creating a blockchain is required, each trader terminal may propagate transaction information to be recorded in the transaction ledger data to each trader terminal.

In addition, as the transaction ledger data is updated and information thereof is shared according to a mutual verification process corresponding thereto, trade of encryption information for creating a blockchain may be processed.

Here, as the current block includes a hash value of a previously generated block for each block corresponding to a predetermined time or unit, the transaction ledger data may be linked to blockchain data having a structure in which a plurality of blocks is sequentially connected in order of generation. Accordingly, verification of forgery or falsification of the transaction ledger data may be easily processed according to verification on the hash value of the blockchain.

Security stability of the blockchain may be formed by participation of data sharers in the system. Accordingly, transaction information blocks including details of sharing data between sharer terminals connected to the blockchain network and details of issuance and trade of encryption information for creating a blockchain may be sequentially stored, and a transaction verification process for sequentially chaining hash values in a block to prevent forgery and falsification may be performed in each trader terminal in a distributed manner.

In the transaction verification process like this, it is general that a previously constructed blockchain network may be a non-random consensus proof-based blockchain network as shown in FIG. 2. Representatively, Proof-of-Work (PoW), Proof-of-Stake (PoS), or the like may be a non-random consensus proof-based blockchain network 200, and a blockchain network such as Bitcoin, Ethereum, and or like may correspond thereto.

In correspondence thereto, node devices 100 according to an embodiment of the present invention may configure a neural consensus proof module cluster, and the neural consensus proof module cluster may configure a new block by combining neural consensus validity verification data on the basis of a random consensus proof method, and may process to propagate the new block through the non-random consensus blockchain network 200.

Accordingly, the non-random consensus blockchain network 200 shares again the propagated block data within the network, and it may be processed to generate a next block again by the node device 100 constituting the neural consensus proof module cluster. Since proof of PoW, PoS, and the like is not required separately in this process, it is possible to construct a new random consensus blockchain network system 1000 that can implement decentralization in a non-competition manner.

That is, according to an embodiment of the present invention, as a neural consensus proof module cluster, which makes it possible to use an existing non-random consensus proof-based blockchain network 200 as a random consensus proof-based blockchain network 1000, is constructed using node devices 100, it is possible to provide a node terminal device 100 that forms a network, which allows a random consensus proof-based blockchain network to operate on a previously constructed blockchain network, while controlling the previously constructed blockchain network of an existing PoW or PoS method not to operate in the PoW or PoS method any longer, or controlling to operate in a limited manner according to the minimum number of nodes of Byzantine Fault Tolerance Agreement consensus.

Accordingly, as a previously constructed non-random consensus proof-based blockchain network may be switched to be utilized as a random consensus proof-based blockchain network while maintaining the infrastructure and utility as much as possible, it is possible to provide an efficient and fair neural consensus proof-based distributed consensus process while preventing waste of resources and social cost. Here, although a nonce chain and hash confirmation process configured based on a one-time random number may be used to prove the participation qualification of the random consensus, this is only an example, and it is possible to designate the random consensus or prove the participation qualification in various other ways.

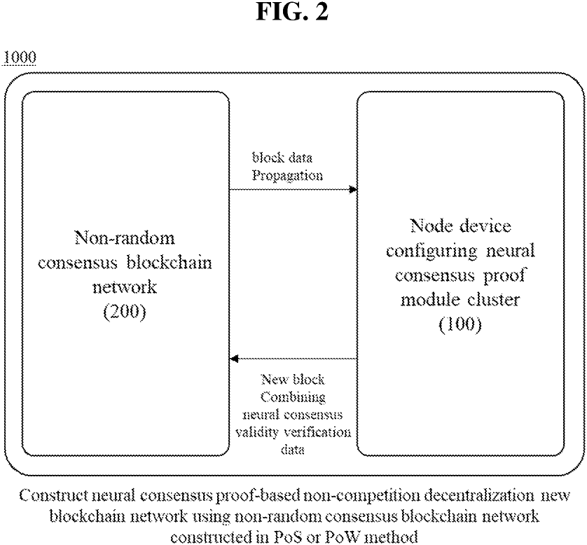

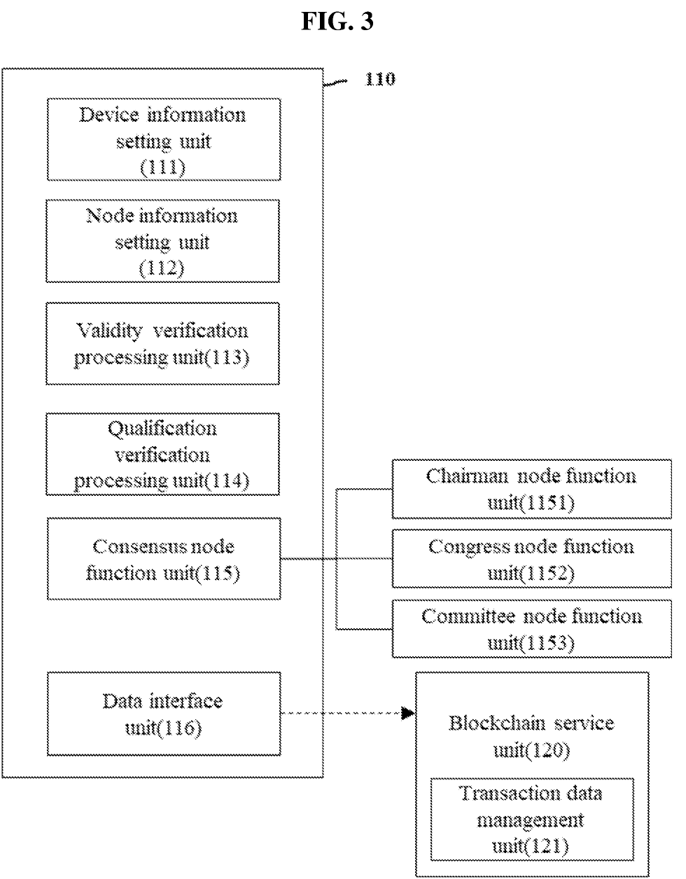

More specifically, referring to FIGS. 3 and 4, FIG. 3 is a block diagram showing a node device according to an embodiment of the present invention in more detail, and FIG. 4 is a conceptual view for explaining the configuration of a neural consensus proof module cluster and the overall process according to an embodiment of the present invention.

Node terminals 100 of the blockchain system 1000 according to an embodiment of the present invention may be included in a neural consensus proof module cluster for configuring a next block by a random node selection process, and may include a neural consensus proof module 110 included in the neural consensus proof module cluster to perform a random consensus proof process according to an embodiment of the present invention.

In addition, the node terminals 100 are connected to the non-random consensus blockchain network 200, and may include a blockchain service unit 120 that performs a shared propagation process of a next block configured by a random consensus proof process through the non-random consensus blockchain network 200.

Accordingly, in an embodiment of the present invention, the node terminals 100 may be node terminals 100 selected by a random consensus selection process while participating in the non-random consensus blockchain network 200 to be selectively granted with a right to generate each block according to the consensus agreement, through which the random consensus blockchain network system 1000 may be constructed independently.

In addition, as shown in FIG. 4, the node terminals 100 may selectively perform the functions of a fourth node terminal that is a general node, a third node terminal that is a participating node, a second node terminal that is a congress node, and a first node terminal that is a committee node.

The neural consensus proof module cluster may be constructed based on a third node terminal, which is a terminal registered as a participating node. The participating node, which is a third node terminal, may verify participation qualification on the basis of the next consensus selection information identified from the consensus validity verification data of the newly propagated block, and the second node terminal may be a terminal that processes a congress node function operation by identifying whether a congress node is selected according to a result of the verification. The first node terminal may be a terminal that processes the committee node function operation by identifying whether a committee node is selected according to a result of the verification.

The node terminal 100 selected as a congress node may perform a candidate block presentation and consensus process like the second node terminal shown in FIG. 4, and the node terminal 100 selected as a committee node may perform a process of configuring and distributing consensus validity verification data of the next block by determining a consensus block and collecting signature information. Here, the consensus validity verification data may include consensus process verification data, multi-signature information, and next consensus selection information, and may be propagated through the previously constructed non-random consensus blockchain network 200.

According to the process of configuring and propagating a new block, the proof process of the existing non-random consensus blockchain network 200 may be limited, and generation of a next block based on PoW or PoS proof between node terminals 100 may be processed only in an exceptional case where the number of nodes is smaller than a number that is set based on the Practical Byzantine Fault Tolerance (PBFT) threshold.

On the other hand, the participation qualification and verification information of the node terminal 100 may be calculated based on a random value calculated for each individual node according to registration of participating nodes, and may be mutually disclosed and verified, for which a nonce chain may be used as described above. For example, on the basis of the qualification verification value of its own according to the hash processing performed using the nonce value included in the next consensus selection information and the height value of the current block, the node terminal 100 may be determined as at least one among a participating node, a congress node, a committee node, and a chairman node.

In addition, as shown in FIG. 3, the node terminal 100 according to an embodiment of the present invention includes a device information setting unit 111, a node information setting unit 112, a validity verification processing unit 113, a qualification verification processing unit 114, a consensus node function unit 115, and a data interface unit 116.

The device information setting unit 111 acquires, stores, and manages device information of the terminal 100 in which the neural consensus proof module 110 is installed. Here, the device information may include at least one among node name information, device address information, device performance information, device reliability information, and use network information of the terminal 100. The device information may be used to identify or construct a neural consensus proof module cluster to perform a voting consensus process, and the like.

The node information setting unit 112 sets node information for registration of the non-random consensus blockchain network 200 and participating nodes. The set node information may include blockchain network client address information, and the terminal 100 may acquire or share block information by accessing the blockchain network through the blockchain network client address information.

The validity verification processing unit 113 acquires new block data propagated through the non-random consensus blockchain network 200, extracts validity verification data from the new block data, and acquires neural consensus designation information of the next block generated based on the random consensus proof process according to the verification process on the validity verification data.

In addition, the consensus node function unit 115 is selectively operated based on the neural consensus designation information of the next block to generate validity verification data of the next block, and may selectively operate at least one among a chairman node function unit 1151, a congress node function unit 1152, and a committee node function unit 1153. Although the chairman node function unit 1151 may be selectively operated through comparison of the neural consensus designation information with at least a part of the nonce value of a designated node terminal 100, the present invention is not limited to such a selection method.

First, the chairman node function unit 1151 may perform a chairman process corresponding to the congress and committee nodes, and may collect delegation information and participation qualification verification information of valid transaction blocks obtained from the transaction pool of the blockchain network, together with next block consensus candidate information, from the congress node. Accordingly, 3f+1 (f is a natural number) or more congress nodes may be selected for the next block, and 2f+1 or more committee nodes may be selected.

In addition, the congress node function unit 1152 may transmit the delegation information and participation qualification verification information of the valid transaction block obtained from the transaction pool of the non-random consensus blockchain network 200 to the node terminal 100 in which the chairman node function unit 1151 is operated.

Then, the chairman node function unit 1151 may select, as a candidate block, a block that matches with a consensus quorum or more of the congress nodes among the transaction blocks proposed by the congress node, and transfer a message requesting a partial signature process on a multi-signature area indicating consensus on the candidate block to the node terminals 100 in which the committee node function unit 1153 is operated. For example, as the chairman node function unit 1151 may determine a transaction data candidate block that matches f+1 transaction data candidate blocks among 2f+1 transaction data candidate blocks, and transmit the message requesting a partial signature process on a multi-signature area to the committee node function unit 1153, the node terminal 100 in which the committee node function unit 1153 is operated may process partial signature indicating a consensus corresponding to the candidate block and transmit a result of the partial signature to the node terminal 100 in which the chairman node function unit 1151 is operated.

Accordingly, the chairman node function unit 1151 verifies the candidate block for which the multi-signature process has been completed according to the consensus of the committee and determines the candidate block as a distribution block, and generates a new block by generating validity verification data corresponding to the consensus process and combining the validity verification data with the distribution block.

The data interface unit 116 may convert the generated new block into the format of the non-random consensus blockchain network 200 and transmit the new block to the blockchain service unit 120.

In addition, the blockchain service unit 120 may propagate the new block through the non-random consensus blockchain network 200, and the new block may be added to the transaction data memory pool, as well as being propagated through the non-random consensus blockchain network 200, according to the operation of a transaction data management unit 121.

Meanwhile, although not shown, the node terminal 100 device may include a memory that can be used by the blockchain service unit 120 and the neural consensus proof module 110 described above. The memory may include computer-readable instructions, and the blockchain service unit 120 and the neural consensus proof module 110 may perform the operations mentioned above as the instructions stored in the memory are executed in a processor. The memory may be a volatile memory or a non-volatile memory.

The memory may include a storage device to store data of the user. The storage device may be an embedded multimedia card (eMMC), a solid-state drive (SSD), a universal flash storage (UFS), or the like. The storage device may include at least one non-volatile memory device. The non-volatile memory device may be NAND flash memory, vertical NAND (VNAND) flash memory, NOR flash memory, resistive random-access memory (RRAM), phase-change memory (PRAM), magneto-resistive Random Access Memory (MRAM), Ferroelectric Random Access Memory (FRAM), Spin Transfer Torque Random Access Memory (STT-RAM), or the like.

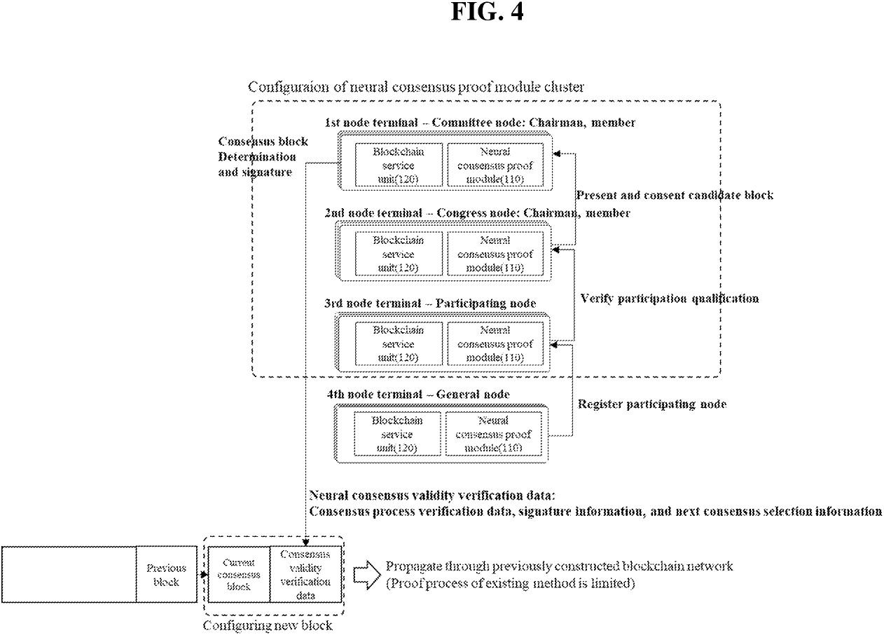

FIG. 5 is a flowchart illustrating an operation method of a node terminal 100 according to an embodiment of the present invention.

Referring to FIG. 5, in the node terminal 100 according to an embodiment of the present invention, when new block data propagated through the previously constructed non-random consensus blockchain network 200 is acquired (S101), the validity verification processing unit 113 extracts validity verification data from the new block data, and acquires consensus designation information according to the verification process on the validity verification data (S103).

The validity verification processing unit 113 may acquire neural consensus designation information of the next block generated based on the random consensus proof process according to the verification process on the validity verification data (S105), and as described above, the validity verification data may include consensus process verification data corresponding to the random consensus proof process.

For example, the consensus process verification data is member qualification verification information of a congress node that processes consensus on transaction data, and may include nonce chain-based qualification proof hash data and multi-signature data formed by combining partial signatures of the congress node. In addition, the neural consensus designation information of the next block may include nonce information for verifying the participation qualification of a neural consensus corresponding to the next block.

Thereafter, it is determined whether the node terminal 100 is selected as a node constituting a neural consensus proof cluster node for the next block (S107), and when it is selected as the node, whether the node is a chairman node is identified on the basis of the consensus designation information (S109).

When the node is not designated as a chairman node, delegation information and participation qualification verification information of a valid transaction block obtained from the transaction pool of the blockchain network according to each qualification may be transferred to the congress chairman node (S113).

Accordingly, the node terminal 100 in which the chairman node function unit 1151 is operated may collect delegation information and next block consensus candidate information from other nodes (S115).

In addition, the node terminal 100 in which the chairman node function unit 1151 is operated determines a consensus candidate block from the node terminal 100 in which the congress node function unit 1152 is operated, and transfers a message requesting a partial signature process on a multi-signature area indicating consensus on the candidate block to a committee member node (S117).

Then, the node terminal 100 in which the chairman node function unit 1151 is operated verifies the candidate block for which the multi-signature process has been completed according to the consensus of the committee and determines the candidate block as a distribution block (S119), generates a new block by generating validity verification data and combining the validity verification data with the distribution block (S121), and registers the combined new block in the transaction pool of the non-random consensus blockchain network 200, and propagates the new block through the previously constructed non-random consensus blockchain network 200 (S123).

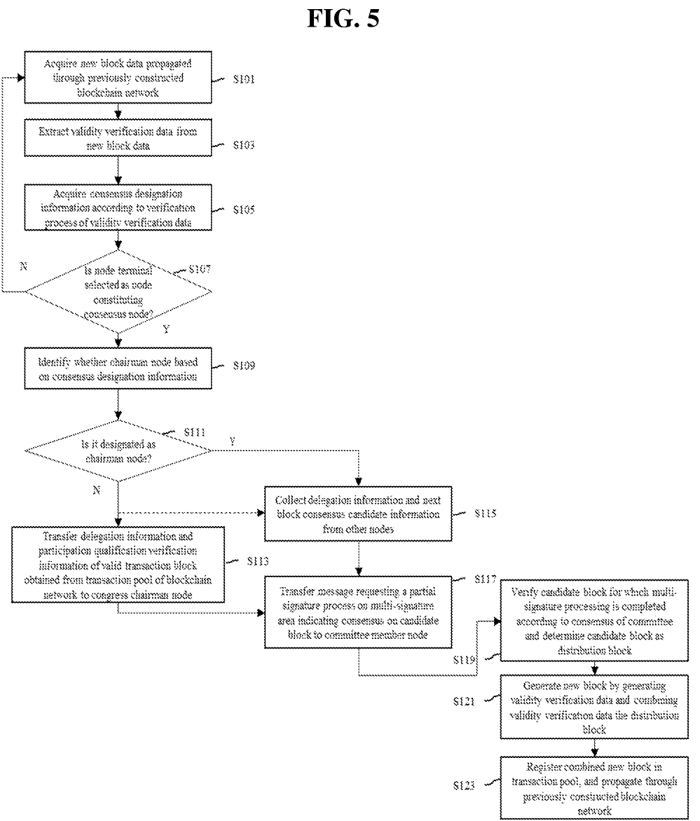

FIGS. 6 to 9 are views showing step-by-step data processed by a consensus proof module node device according to an embodiment of the present invention.

FIG. 6 is a view showing an example of delegation information transferred to the chairman node at the delegation request step for configuring the current block. The delegation information may include a nonce value corresponding to the current block height, Qi value information that each congress node desires to use for multi-signature, transaction data, next consensus congress candidate information, and a nonce value of the next block height.

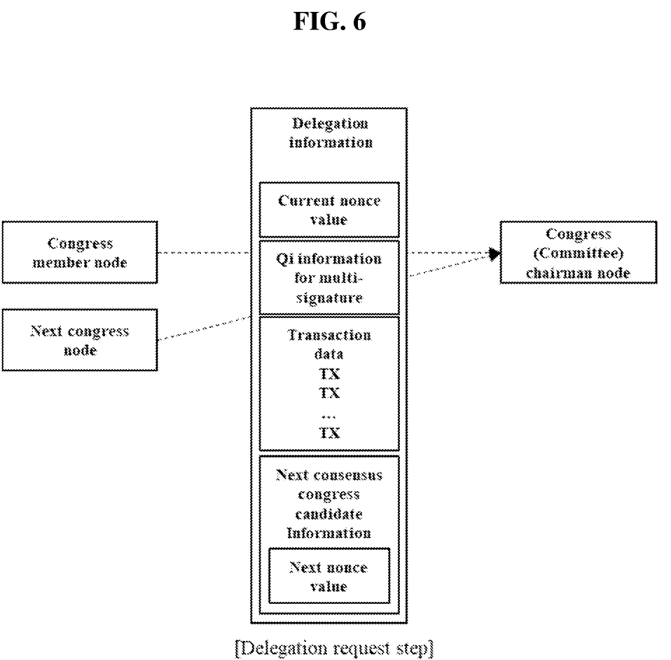

In addition, FIG. 7 is a view showing an example of candidate block information transferred from the chairman node to the committee node at the preparation step, and the candidate block information may include header information including a MerkleRoot or the like, candidate block transaction data, congress designation information of the next consensus, multi-signature request data (Q data integrating Qi, public key Pk), and verification data. The verification data may include, for example, bitmap information or the like that can identify server information that has proposed the transaction data, and therefore, it is possible to prevent a case or the like proposed by the chairman node itself.

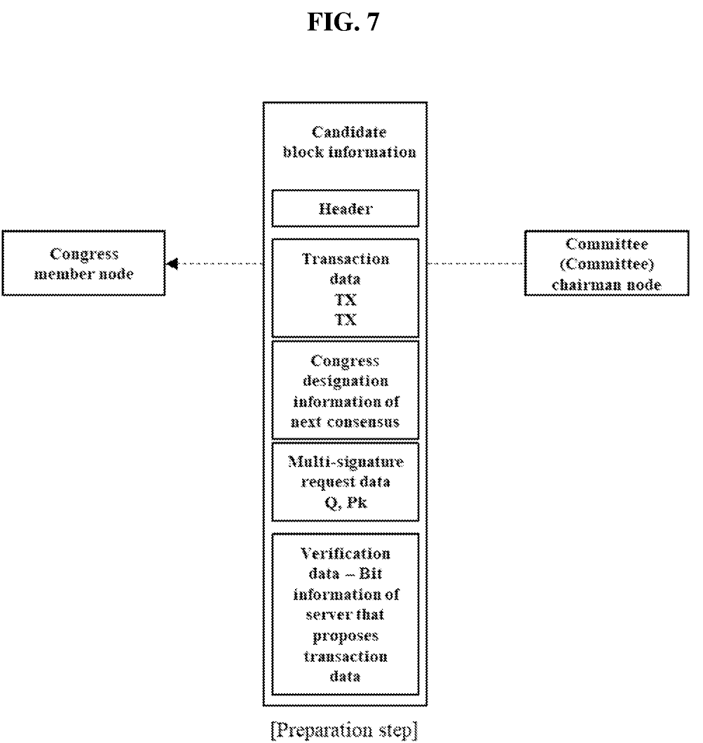

In addition, FIG. 8 is a view showing an example of partial signature data propagated from the committee node to the chairman node in the process of processing committee verification, and the chairman node may calculate signature completion data S by integrating the partial signature data Si.

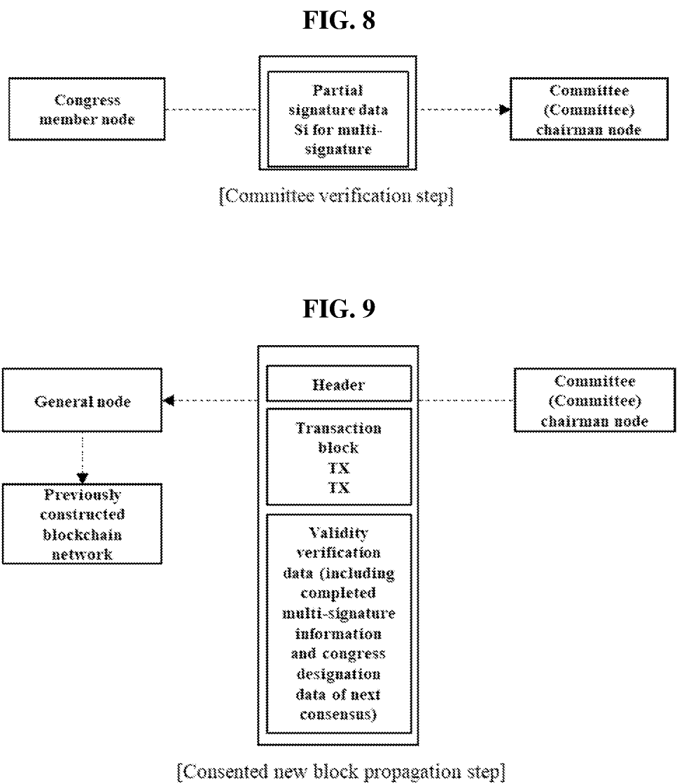

Meanwhile, FIG. 9 is a view showing the configuration of a new block generated and propagated according to an embodiment of the present invention, and the new block may include header information, transaction block information, and validity verification data. As described above, the validity verification data may include next consensus designation information, completed multi-signature information, and various information that can prove the consensus process and participation qualification. In addition, the header information may include a MerkleRoot value or the like for validity verification on the block data itself.

Accordingly, the validity verification processing unit 113 may primarily verify the consensus process by identifying multi-signature information, and then secondarily verify the consensus process by identifying whether the MerkleRoot value of the header is normal, and make it possible to securely process the transaction block by tertiarily verifying the consensus process in a way of comparing it with a MerkleRoot value calculated again using the transaction block information.

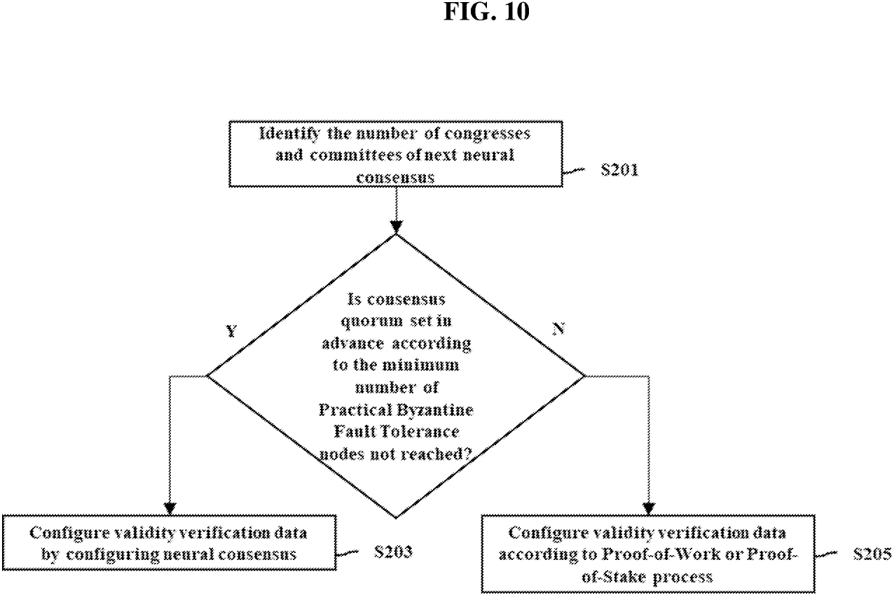

FIG. 10 is a flowchart illustrating an operation method of a node terminal device according to another embodiment of the present invention.

Referring to FIG. 10, the node terminal 100 according to another embodiment of the present invention first identifies the number of congress and committee nodes of the next neural consensus (S201) .

Then, the node terminal 100 determines whether a consensus quorum set in advance according to the minimum number of Practical Byzantine Fault Tolerance nodes is not reached.

For example, the consensus quorum may be determined by the maximum Byzantine number (the maximum number of malicious nodes allowed) that can be selected by the node selection probability P in correspondence to the number N of participating nodes, and there should be at least 3f+1 (f is a natural number) congress nodes and at least 2f+1 committee nodes to satisfy the consensus quorum.

When the number of consensus nodes is smaller than the quorum of the neural consensus congress and committee set in advance according to the minimum number of Practical Byzantine Fault Tolerance nodes, the node terminal 100 performs a selective exception process of forming the validity verification data of the next block in the method of Proof-of-Work (PoW) or Proof-of-Stake (PoS) (S205).

Contrarily, when the number of consensus nodes is larger than the quorum of the neural consensus congress and committee set in advance according to the minimum number of Practical Byzantine Fault Tolerance nodes, the Proof-of-Work (PoW) or Proof-of-Stake (PoS) process of the non-random consensus proof-based blockchain network is limited, and a new block may be generated and propagated by configuring a neural consensus and configuring validity verification data using the process of FIG. 5 described above (S203) .

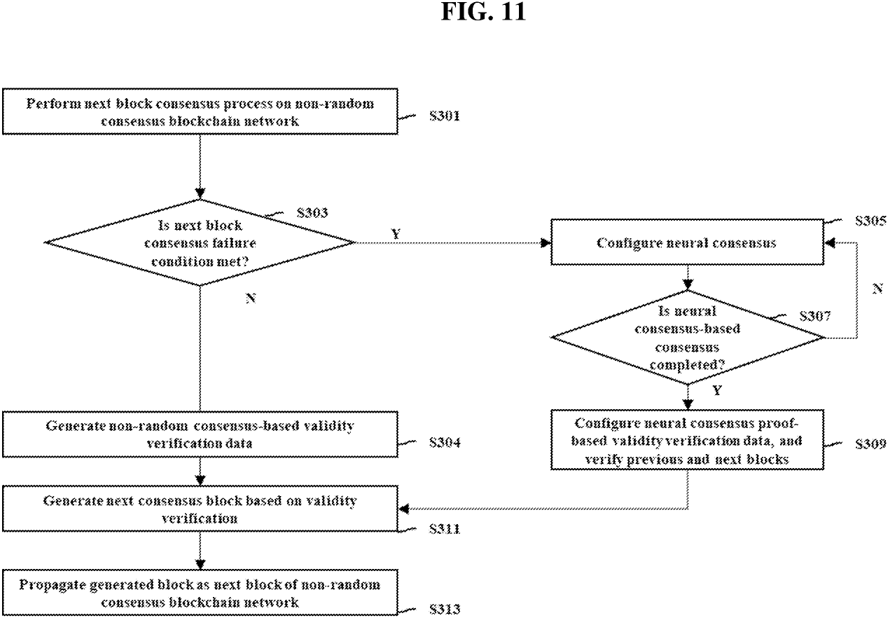

FIG. 11 is a flowchart illustrating an operation method of a node terminal device according to another embodiment of the present invention.

Referring to FIG. 11, the processes of identifying or constructing a neural consensus proof module cluster and performing a voting consensus process according to another embodiment of the present invention may be used to quickly generate a next block in order to guarantee continuity when a failure occurs in the non-random consensus blockchain network 200.

Generally, in the case of a non-random consensus method of proof-of-work or proof-of-stake of Ethereum or the like, problems such as timeout of block generation period or unstable consensus due to duplicated transactions occur due to abnormal service operating or overload. Therefore, the current non-random consensus blockchain network 200 does not sufficiently guarantee continuity of block generation due to occurrence of temporary service suspension, hard fork, or the like, and is vulnerable to failure.

Accordingly, the process of identifying or constructing a neural consensus proof module cluster and performing a voting consensus process according to an embodiment of the present invention may be complementarily performed when a failure occurs to be applied in a way of guaranteeing continuity in operating an existing non-random consensus blockchain network 200.

This may be implemented without constructing a separate infrastructure by setting one or more of the node terminals constituting the existing non-random consensus blockchain network 200 to operate as a node device 100 constituting a neural consensus proof module cluster described above when a failure condition set in advance occurs.

More specifically, referring to FIG. 11, the node terminal 100 according to an embodiment of the present invention may be a node terminal constituting the non-random consensus blockchain network 200, and operate as a node device 100 constituting a neural consensus proof module cluster when a block consensus failure condition set in advance is met so that it may be configured as a terminal that configures validity verification data based on neural consensus and propagates it as a next block.

To configure such a terminal, the node terminal 100 may be operated as a node device 100 constituting a neural consensus proof module cluster set in advance, and unlike the method of switching an existing blockchain and operating the node terminal as described above, the node terminal 100 may be operated in the continuity guarantee mode to guarantee continuity.

For example, as described above, the node terminal 100 may be operated in any one among a network switch mode of switching an existing non-random consensus blockchain network 200 to a random consensus blockchain network, and a continuity guarantee mode of subsidiarily operating the node terminal 100 when a failure occurs in the existing non-random consensus blockchain network 200, and FIG. 11 describes the operation when the node terminal 100 is operated in the continuity guarantee mode.

First, the node terminal 100 performs a next block consensus process on a general non-random consensus blockchain network 200 (S301).

Then, the node terminal 100 determines whether a next block consensus failure condition is met (S303).

Here, various conditions may be set in advance as the next block consensus failure condition, and preferably, a timeout condition of a case where a block is not generated during a first time period may be used. For example, the first time period may be the same as a second time period, which is a timeout period specified in the proof-of-work or proof-of-stake process of a non-random consensus blockchain network 200.

In addition, in consideration of the speed of work, the first time period may be set to be shorter than the second time period so that configuration of the neural consensus proof module cluster is processed before the timeout of the non-random consensus blockchain network 200.

In addition, the next block consensus failure condition may be, for example, temporary service suspension or the like. For example, it may be set to continuously perform a subsidiary block generation process according to configuration of the neural consensus proof module cluster when the service of the non-random consensus blockchain network 200 is suspended due to a hard fork or a temporary service operation problem.

When the failure condition for the next block consensus is not met, non-random consensus-based validity verification data on the non-random consensus blockchain network 200 is generated in a general method such as proof-of-work or proof-of-stake (S304).

Then, when the failure condition of the next block consensus is met, the node terminal 100 described above may be operated as a node device 100 constituting the neural consensus proof module cluster, and performs a process of configurating a neural consensus proof module cluster of a random method and a consensus process based thereon described in FIGS. 4 and 5 (S305).

When a consensus based on the neural consensus proof module cluster is completed (S307), the node terminal 100 configures neural consensus proof-based validity verification data, and verifies validity of data between the previous block and the next block configured on the non-random consensus blockchain network 200 on the basis of the configured validity verification data (S309).

Here, specific block height (HEIGHT) information, previous block information, and next block information may be used for validity verification of data between the previous block and the next block, and through the validity verification based on this, generation of a block of a non-random consensus format that can be used on the non-random consensus blockchain network 200 may be performed.

Thereafter, the node terminal 100 generates the next consensus block based on the non-random consensus-based validity verification data of step S304 or neural consensus proof-based validity verification data verified at step S309 (S311).

For example, the node terminal 100 may generate a next block including validity verification data based on neural consensus proof, and generate the next block in the non-random consensus format verified according to step S309. More specifically, when the height of the current latest block is 100, the node terminal 100 may generate a next block that restarts consensus on the non-random consensus blockchain network 200 from a block of 110 height.

Then, the node terminal 100 propagates the generated block as the next block of the non-random consensus blockchain network 200 (S313).

As a neural consensus proof-based block generation process, which is subsidiarily operated when a failure occurs in the non-random consensus blockchain network 200 of a proof-of-work or proof-of-stake method such as Ethereum, Bitcoin, or the like, is performed according to the process of the node terminal 100 as described above, continuity of service can be guaranteed sufficiently.

Meanwhile, various embodiments described herein may be implemented in a computer-readable recording medium using, for example, software, hardware, or a combination thereof. According to hardware implementation, the embodiments described herein may be implemented using at least one among application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for performing a function. In some cases, such embodiments may be implemented by a control unit.

In addition, the embodiments described above may be implemented by a hardware component, a software component, and/or a combination of the hardware component and the software component. For example, the devices, methods, and components described in the embodiments may be implemented using one or more general purpose computers or special purpose computers, such as a processor, a controller, a central processing unit (CPU), a graphics processing unit (GPU), an arithmetic logic unit (ALU), a digital signal processor, a microcomputer, a field programmable gate array (FPGA), a programmable logic unit (PLU), a microprocessor, an application specific integrated circuit (ASIC), and any other devices capable of executing instructions and responding thereto.

In addition, the methods according to an embodiment of the present invention described above may be manufactured as a program to be executed on a computer. In addition, the program may be stored in a computer-readable recording medium, and examples of the computer-readable recording medium include ROM, RAM, CD-ROM, magnetic tapes, floppy disks, optical data storage devices and the like.

The computer-readable recording medium may be distributed in computer systems connected through a network, so that computer-readable codes may be stored and executed in a distributed manner. In addition, functional programs, codes, and code segments for implementing the method may be easily inferred by the programmers in the art to which the present invention belongs.

In addition, although preferred embodiments of the present invention have been illustrated and described above, the present invention is not limited to the specific embodiments described above, and various modified embodiments can be made by those skilled in the art without departing from the gist of the invention claimed in the claims, and in addition, these modified embodiments should not be individually understood from the spirit or perspective of the present invention.

1. An operation method of a node device connected to a non-random consensus proof-based blockchain network, the method comprising the steps of:
acquiring new block data propagated through the blockchain network; and
performing a neural consensus proof-based block generation process corresponding to the new block data according to a condition set in advance, wherein
the neural consensus proof-based block generation process includes the steps of:
extracting validity verification data from the new block data;
acquiring neural consensus designation information of a next block generated based on a random consensus proof process according to a verification process on the validity verification data; and
generating validity verification data of the next block by selectively operating a consensus node function processor on the basis of the neural consensus designation information of the next block.

2. The method according to claim 1, wherein the validity verification data includes consensus process verification data corresponding to the random consensus proof process.

3. The method according to claim 2, wherein the consensus process verification data includes member verification information of a congress node that processes consensus on transaction data, and multi-signature data formed by combining partial signatures of the congress node.

4. The method according to claim 1, wherein the neural consensus designation information of the next block includes nonce information for verifying participation qualification of a neural consensus corresponding to the next block.

5. The method according to claim 1, wherein the non-random consensus proof-based blockchain network is a blockchain network of a Proof-of-Work (PoW) or Proof-of-Stake (Pos) method.

6. The method according to claim 5, further comprising the steps of:
identifying the number of consensus nodes identified from the neural consensus designation information of the next block; and
performing a selective exception process of forming the validity verification data of the next block in the method of Proof-of-Work (PoW) or Proof-of-Stake (PoS) when the number of consensus nodes is smaller than a quorum of the neural consensus congress and committee set in advance according to the minimum number of Practical Byzantine Fault Tolerance nodes.

7. The method according to claim 5, further comprising the step of limiting the Proof-of-Work (PoW) or Proof-of-Stake (PoS) process of the non-random consensus proof-based blockchain network when the number of consensus nodes is larger than the quorum of the Neural consensus congress and committee set in advance according to the minimum number of Practical Byzantine Fault Tolerance nodes.

8. The method according to claim 1, further comprising the step of configuring the next block that combines the generated validity verification data and the new block, and propagating the next block through the blockchain network, wherein the propagating step includes the step of propagating the next block using a block propagation process of the non-random consensus proof-based blockchain network.

9. The method according to claim 1, wherein the neural consensus proof-based block generation process is performed only when a next block consensus failure condition of the non-random consensus blockchain network occurs.

10. The method according to claim 9, wherein the next block consensus failure condition includes a timeout condition of a case where no block is generated during a first time period, and the first time period is equal to or short than a second time period, which is a timeout period specified in the non-random consensus blockchain network.

11. The method according to claim 9, further comprising the steps of:
generating the next block of a non-random consensus format that can be used in the non-random consensus blockchain network by using the new block information, the validity verification data, and the previous block information to guarantee continuity of the non-random consensus blockchain network; and
propagating the next block through the blockchain network.

12. A node device connected to a non-random consensus proof-based blockchain network to perform a neural consensus proof-based block generation process corresponding to new block data according to a condition set in advance when the node device acquires the new block data propagated through the blockchain network, the node device comprising:
a validity verification processing processor acquiring the new block data propagated through the blockchain network, extracting validity verification data from the new block data, and acquiring neural consensus designation information of the next block generated based on the random consensus proof process according to the verification process on the validity verification data; and
a consensus node function processor selectively opertated based on the neural consensus designation information of the next block to generate validity verification data of the next block.

13. The device according to claim 12, wherein the validity verification data includes consensus process verification data corresponding to the random consensus proof process.

14. The device according to claim 13, wherein the consensus process verification data includes member verification information of a congress node that processes consensus on transaction data, and multi-signature data formed by combining partial signatures of the congress node.

15. The device according to claim 12, wherein the neural consensus designation information of the next block includes nonce information for verifying participation qualification of a neural consensus corresponding to the next block.

16. The device according to claim 12, wherein the non-random consensus proof-based blockchain network is a blockchain network of a Proof-of-Work (PoW) or Proof-of-Stake (Pos) method.

17. The device according to claim 16, wherein the consensus node function processor identifies the number of consensus nodes identified from the neural consensus designation information of the next block, and performs a selective exception process of forming the validity verification data of the next block in the method of Proof-of-Work (PoW) or Proof-of-Stake (PoS) when the number of consensus nodes is smaller than a quorum of the neural consensus congress and committee set in advance according to the minimum number of Practical Byzantine Fault Tolerance nodes.

18. The device according to claim 17, wherein the consensus node function processor limits the Proof-of-Work (PoW) or Proof-of-Stake (PoS) process of the non-random consensus proof-based blockchain network when the number of consensus nodes is larger than the quorum of the Neural consensus congress and committee set in advance according to the minimum number of Practical Byzantine Fault Tolerance nodes.

19. The device according to claim 12, further comprising a blockchain service processor configuring the next block that combines the generated validity verification data and the new block, and propagating the next block through the blockchain network, wherein the blockchain service processor propagates the next block using a block propagation process of the non-random consensus proof-based blockchain network.

20. The device according to claim 12, wherein the neural consensus proof-based block generation process is performed only when a next block consensus failure condition of the non-random consensus blockchain network occurs.

21. The device according to claim 20, wherein the next block consensus failure condition includes a timeout condition of a case where no block is generated during a first time period, and the first time period is equal to or short than a second time period, which is a timeout period specified in the non-random consensus blockchain network.

22. The device according to claim 20, further comprising a blockchain service processor configuring the next block that combines the generated validity verification data and the new block, and propagating the next block through the blockchain network, wherein the blockchain service processor generates the next block of a non-random consensus format that can be used in the non-random consensus blockchain network by using the new block information, the validity verification data, and the previous block information to guarantee continuity of the non-random consensus blockchain network.

23. A blockchain network platform system comprising:
a non-random consensus proof-based blockchain network; and
a neural consensus proof module cluster for generating a new block combined with random consensus proof-based neural consensus validity verification data by using block data propagated from the non-random consensus proof-based blockchain network according to a condition set in advance, wherein the new block is propagated through the non-random consensus proof-based blockchain network.

24. The system according to claim 23, wherein the neural consensus proof module cluster is configured of one or more node devices for acquiring the new block data propagated through the non-random consensus proof-based blockchain network, extracting the validity verification data from the new block data, acquiring neural consensus designation information of a next block generated based on a random consensus proof process according to a verification process on the validity verification data, generating validity verification data of the next block by selectively operating a consensus node function processor on the basis of the neural consensus designation information of the next block, and configuring the next block that combines the generated validity verification data and the new block, and propagating the next block through the non-random consensus proof-based blockchain network.

25. The system according to claim 23, wherein the validity verification data includes consensus process verification data corresponding to the random consensus proof process, and the consensus process verification data includes member verification information of a congress node that processes consensus on transaction data, and multi-signature data formed by combining partial signatures of the congress node.

26. The system according to claim 23, wherein the neural consensus proof module cluster identifies the number of consensus nodes identified from the neural consensus designation information of the next block, and performs a selective exception process of forming the validity verification data of the next block in the method of Proof-of-Work (PoW) or Proof-of-Stake (PoS) when the number of consensus nodes is smaller than a quorum of the neural consensus congress and committee set in advance according to the minimum number of Practical Byzantine Fault Tolerance nodes.

27. The system according to claim 21, wherein the neural consensus proof module cluster limits the Proof-of-Work (PoW) or Proof-of-Stake (PoS) process of the non-random consensus proof-based blockchain network when the number of consensus nodes is larger than the quorum of the Neural consensus congress and committee set in advance according to the minimum number of Practical Byzantine Fault Tolerance nodes.

28. The system according to claim 21, wherein the neural consensus proof-based block generation process is performed only when a next block consensus failure condition of the non-random consensus blockchain network occurs, and the next block consensus failure condition includes a timeout condition of a case where no block is generated during a first time period, and the first time period is equal to or short than a second time period, which is a timeout period specified in the non-random consensus blockchain network.
